(19) United States
(12) Patent Application Publication
(10) Pub. No.: US 2026/0207402 A1
(43) Pub. Date: Jul. 23, 2026

(54) SIT-TO-STAND ASSIST CHAIR

(71) Applicant: INTRADIN (SHANGHAI) INTELLIGENT MACHINERY CO., LTD., Shanghai (CN)

(72) Inventors: Ping LI, Shanghai (CN); Xuetao QIAO, Shanghai (CN)

(21) Appl. No.: 19/568,952

(22) Filed: Mar. 17, 2026

(30) Foreign Application Priority Data
Jan. 28, 2026 (CN) 202610118618.0

(51) Int. Cl. A61G 5/14; A61G 5/10; A61G 5/12

(52) U.S. Cl. CPC A61G 5/14; A61G 5/1045; A61G 5/122; A61G 5/125

(57) ABSTRACT

A sit-to-stand assist chair, including a base, a seat cushion and a lifting assembly. The seat cushion is movably mounted on the base. The lifting assembly includes a mounting frame, a lifting mechanism and a driving mechanism. The mounting frame is mounted on the base. The lifting mechanism is mounted on the mounting frame. A bottom of the seat cushion is connected to the lifting mechanism. The driving mechanism is mounted on the mounting frame. The driving mechanism is configured to drive the lifting mechanism to lift the seat cushion, and simultaneously drive the seat cushion to entirely perform a sector-shaped flipping motion.

### CROSS-REFERENCE TO RELATED APPLICATIONS

This application claims the benefit of priority from Chinese Patent Application No. 202610118618.0, filed on Jan. 28, 2026. The content of the aforementioned application, including any intervening amendments made thereto, is incorporated herein by reference in its entirety.

### TECHNICAL FIELD

This application relates to sit-to-stand aids, and more particularly toa sit-to-stand assist chair.

### BACKGROUND

With the rapid development of the national economy, the aging issue, as well as the health of the elderly, has gradually attracted social attention. The design of products suitable for elderly users has become an important focus in an aging society. As age increases, elderly people often suffer from osteoporosis and reduced mobility, making it painful for them to stand up after sitting for a long time.

At present, there are some commercially-available chairs or devices designed to assist the elderly in standing, represented by simple elevated armrest designs and partial seat-lifting mechanisms. However, most of the existing products only provide vertical lifting assistance, or are designed to pivot about the front end of the seat in a semi-circular trajectory. These designs fail to adequately consider the physiological characteristics of center-of-gravity transfer and ergonomic requirements during the sit-to-stand process of elderly users. Pure vertical lifting or semi-circular pivoting often cannot effectively assist a user in completing the natural posture transition from sitting to standing, resulting in an unsatisfactory user experience. In view of this, the present disclosure provides a sit-to-stand assist chair to address such issues.

### SUMMARY

In view of this, an object of the disclosure is to provide a sit-to-stand assist chair to overcome the defects in the prior art.

Technical solutions of the present disclosure are described as follows.

A sit-to-stand assist chair, comprising:
a base;
a seat cushion; and
a lifting assembly;
wherein the seat cushion is movably mounted on the base;
the lifting assembly comprises a mounting frame, a lifting mechanism and a driving mechanism;
the mounting frame is mounted on the base;
the lifting mechanism is mounted on the mounting frame;
a bottom of the seat cushion is connected to the lifting mechanism;
the driving mechanism is mounted on the mounting frame; and
the driving mechanism is configured to drive the lifting mechanism to lift the seat cushion and simultaneously drive the seat cushion to entirely perform a sector-shaped flipping motion.

In some embodiments, the mounting frame comprises two fixing plates, a first cross beam and a second cross beam;
the two fixing plates are arranged spaced apart from each other, and are mounted on the base;
the first cross beam and the second cross beam are arranged spaced apart from each other, and are provided between the two fixing plates;
a first end of each of the first cross beam and the second cross beam is fixedly connected to one of the two fixing plates, and a second end of each of the first cross beam and the second cross beam is fixedly connected to the other of the two fixing plates;
the lifting mechanism is hinged to an end of each of the two fixing plates away from the second cross beam; and
a first end of the driving mechanism is hinged to the second cross beam, and a second end of the driving mechanism is hinged to the lifting mechanism.

In some embodiments, the lifting mechanism comprises two linkage assemblies and a crossbar;
the two linkage assemblies are respectively mounted on sides of the two fixing plates that are opposite to each other;
the two linkage assemblies are respectively hinged to the two fixing plates;
the two linkage assemblies are connected to each other via the crossbar; and
the driving mechanism is hinged to the crossbar.

In some embodiments, each of the two linkage assemblies comprises a first linkage part, a second linkage part, and a lifting part;
a first end of the first linkage part is hinged to a corresponding one of the two fixing plates, and a second end of the first linkage part is hinged to a first side of the lifting part;
a first end of the second linkage part is hinged to the corresponding one of the two fixing plates, and a second end of the second linkage part is hinged to a second side of the lifting part;
the first linkage part of one of the two linkage assemblies is fixedly connected to a first end of the crossbar, and the first linkage part of the other of the two linkage assemblies is fixedly connected to a second end of the crossbar; and
the lifting part is fixedly connected to the seat cushion.

In some embodiments, the first end of the first linkage part is hinged to the corresponding one of the two fixing plates via a first hinged shaft, and the second end of the first linkage part is hinged to the first side of the lifting part via a second hinged shaft;
the first end of the second linkage part is hinged to the corresponding one of the two fixing plates via a third hinged shaft, and the second end of the second linkage part is hinged to the second side of the lifting part via a fourth hinged shaft; and
lines connecting the first hinged shaft, the second hinged shaft, the third hinged shaft, and the fourth hinged shaft form a quadrilateral.

In some embodiments, the driving mechanism comprises a telescopic push rod and a motor;
the second cross beam is fixedly sleeved with a first hinged plate;
the crossbar is fixedly sleeved with a second hinged plate;
a first end of the telescopic push rod is hinged to the first hinged plate, and a second end of the telescopic push rod is hinged to the second hinged plate; and
the motor is mounted on an outer wall of the telescopic push rod.

In some embodiments, the base comprises four support legs and a plurality of connecting rods; and the four support legs are each arranged vertically;
two adjacent support legs of the four support legs are fixedly connected to each other via at least one of the plurality of connecting rods, such that the four support legs and the plurality of connecting rods together form a rectangular frame structure.

In some embodiments, each of the four support legs is a telescopic rod; and an outer wall of each of the four support legs is provided with an adjustment rod.

In some embodiments, the sit-to-stand assist chair further comprises a backrest;
wherein the backrest is fixedly mounted on the base; and two sides of the backrest are each provided with a rotatable armrest.

In some embodiments, one of two rotatable armrests is provided with a control button.

Compared to the prior art, the present disclosure has the following beneficial effects.

Regarding the sit-to-stand assist chair provided herein, the driving mechanism drives the lifting mechanism, such that the seat cushion is lifted while simultaneously undergoing a sector-shaped flipping trajectory. This simulates the natural force application pattern of a human body during standing, accommodates the physiological characteristics of center-of-gravity transfer, and satisfies ergonomic requirements during the standing process. As a result, the assist chair provided herein effectively helps the user complete a natural transition from a seated position to a standing position, providing an improved and comfortable user experience.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a three-dimensional structural view of a sit-to-stand assist chair with a seat cushion in a lifted state according to an embodiment of the present disclosure;

FIG. 2 is a three-dimensional structural view of the sit-to-stand assist chair with the seat cushion in a flat state according to an embodiment of the present disclosure;

FIG. 3 is a structural diagram of a lifting mechanism of the sit-to-stand assist chair according to an embodiment of the present disclosure;

FIG. 4 is a structural diagram of a linkage assembly of the sit-to-stand assist chair according to an embodiment of the present disclosure;

FIG. 5 schematically shows a distribution of hinged shafts of the sit-to-stand assist chair according to an embodiment of the present disclosure; and

FIG. 6 schematically shows a lifting trajectory of the sit-to-stand assist chair according to an embodiment of the present disclosure.

In the figures: 1—base; 11—support leg; 12—connecting rod; 13—adjustment rod; 14—caster wheel; 2—seat cushion; 3—lifting assembly; 31—mounting frame; 311—fixing plate; 312—first cross beam; 313—second cross beam; 3131—first hinged plate; 32—lifting mechanism; 321—linkage assembly; 3211—first linkage part; 3212—second linkage part; 3213—lifting part; 3214—first hinged shaft; 3215—second hinged shaft; 3216—third hinged shaft; 3217—fourth hinged shaft; 322—crossbar; 3221—second hinged plate; 33—driving mechanism; 331—telescopic push rod; 332—motor; 34—power supply; 4—backrest; 41—handle; 5—armrest; and 51—control button.

The implementation, functional characteristics, and advantages of the present disclosure will be further described in conjunction with the embodiments and the accompanying drawings.

### DETAILED DESCRIPTION OF EMBODIMENTS

The technical solutions of the present disclosure will be described clearly and completely below in conjunction with the accompanying drawings. It is obvious that described herein are merely some embodiments of the present disclosure, rather than all embodiments of the present disclosure. Based on the embodiments in the present disclosure, all other embodiments obtained by those of ordinary skill in the art without making creative effort shall fall within the scope of the present disclosure defined by the appended claims.

It should be noted that all directional indications (such as up, down, left, right, front, and back) in the embodiments of the present disclosure are used only for explaining the relative positional relationship or movement between the components in a particular attitude (as shown in the accompanying drawings), and the directional indications are correspondingly changed if the particular attitude is changed.

Furthermore, as used herein, terms such as “first” and “second” are only descriptive, and should not be construed as indicating or implying their relative importance or implicitly specifying the number of technical features indicated. As a result, a feature defined as “first” or “second” may include at least one of such features, either explicitly or implicitly. In addition, “and/or” includes three solutions, for example, “A and/or B” includes technical solution A, technical solution B, and a combination thereof. In addition, the technical solutions of various embodiments may be combined with each other on the premise that the combined solution can be implemented by those of ordinary skill in the art. When the combination of technical solutions appears to be contradictory or unimplementable, it should be understood that such a combination does not exist, and is not included within the scope of the present disclosure.

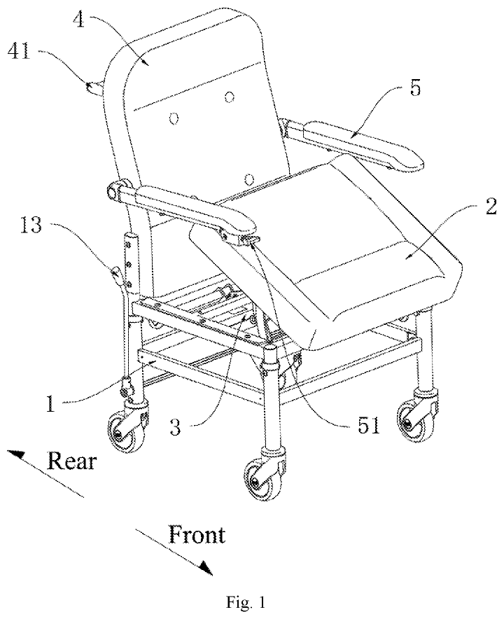

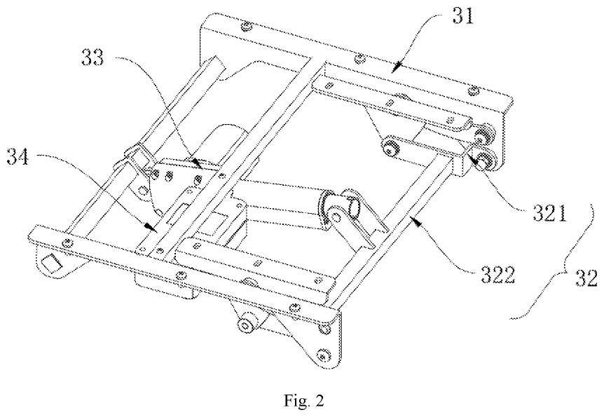

As shown in FIGS. 1-2, an embodiment of the present disclosure provides sit-to-stand assist chair, including a base 1, a seat cushion 2, and a lifting assembly 3. The seat cushion 2 is movably arranged on the base 1. The lifting assembly 3 includes a mounting frame 31, a lifting mechanism 32, and a driving mechanism 33. The mounting frame 31 is mounted on the base 1. The lifting mechanism 32 is mounted on the mounting frame 31. A bottom of the seat cushion 2 is connected to the lifting mechanism 32. The driving mechanism 33 is mounted on the mounting frame 31. The driving mechanism 33 is configured to drive the lifting mechanism 32 to lift the seat cushion 2 and simultaneously drive the seat cushion 2 to entirely perform a sector-shaped flipping motion.

In this embodiment, the base 1 has a rectangular frame structure. When the lifting mechanism 32 and the driving mechanism 33 drive two ends of the seat cushion 2 to be obliquely upward at an angle toward a front end of the assist chair while performing a sector-shaped flipping motion, a lifting height H1 at a front end of the seat cushion 2 is smaller than a lifting height H2 at a rear end of the seat cushion 2. Meanwhile, the front end of the seat cushion 2 undergoes a forward horizontal displacement H3. A flipping angle at the front end of the seat cushion 2 is smaller than a flipping angle at the rear end of the seat cushion 2, thereby forming a sector-shaped motion trajectory.

During operation, the driving mechanism 33 drives the lifting mechanism 32. Under the action of the lifting mechanism 32, the rear end of the seat cushion 2 is lifted upward and flipped forward at a relatively high speed and with a larger angular displacement, while the front end of the seat cushion 2 moves at a relatively lower speed and with a smaller angular displacement. As a result, the posterior portion of the user's hips is first lifted and pushed forward, causing the user's upper body to naturally lean forward under the combined effect of gravity and the inclination of the seat cushion 2, thereby shifting the center of gravity forward. This effectively reduces the load on the user's hip and knee joints during standing and helps the user complete the transition from a seated position to a standing position more easily and naturally. When the user needs to sit down, the driving mechanism 33 reversely drives the lifting mechanism 32, causing the seat cushion 2 to move rearward and downward under the action of the lifting mechanism 32 and gradually return to an initial horizontal state. The process is smooth, and during this motion, the forward-tilted seat cushion 2 supports the user's hips when sitting, preventing discomfort or safety hazards caused by excessive speed or instability.

Regarding the sit-to-stand assist chair provided herein, the driving mechanism 33 drives the lifting mechanism 32, such that the seat cushion 2 is lifted while simultaneously undergoing a sector-shaped flipping trajectory. This simulates the natural force application pattern of a human body during standing, accommodates the physiological characteristics of center-of-gravity transfer, and satisfies ergonomic requirements during the standing process. As a result, the assist chair provided herein effectively helps the user complete a natural transition from a seated position to a standing position, providing an improved and comfortable user experience.

In an embodiment, the mounting frame 31 includes two fixing plates 311, a first cross beam 312, and a second cross beam 313. The two fixing plates 311 are arranged spaced apart from each other, and are mounted on the base 1. The first cross beam 312 and the second cross beam 313 are arranged spaced apart from each other, and are provided between the two fixing plates 311. A first end of each of the first cross beam 312 and the second cross beam 313 is fixedly connected to one of the two fixing plates, and a second end of each of the first cross beam 312 and the second cross beam 313 is fixedly connected to the other of the two fixing plates 311. The lifting mechanism 32 is hinged to an end of each of the two fixing plates 311 away from the second cross beam 313.A first end of the driving mechanism 33 is hinged to the second cross beam 313, and a second end of the driving mechanism 33 is hinged to the lifting mechanism 32.

In this embodiment, the two fixing plates 311 are arranged in parallel. The first cross beam 312 and the second cross beam 313 are arranged perpendicular to the two fixing plates 311. The first cross beam 312 and the second cross beam 313 are connected to the two fixing plates 311 to form an integral frame, serving as a stable support for the lifting mechanism 32 and the driving mechanism 33.

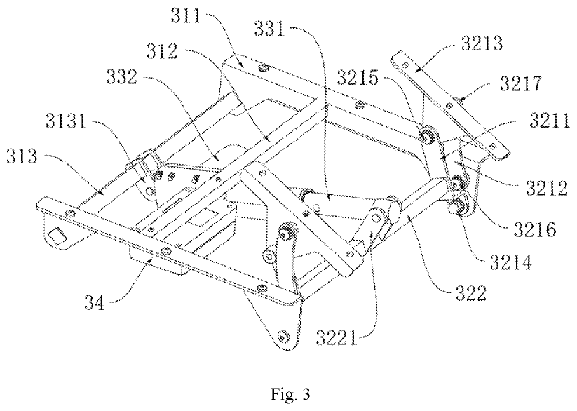

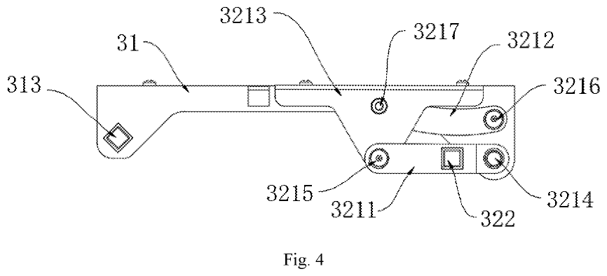

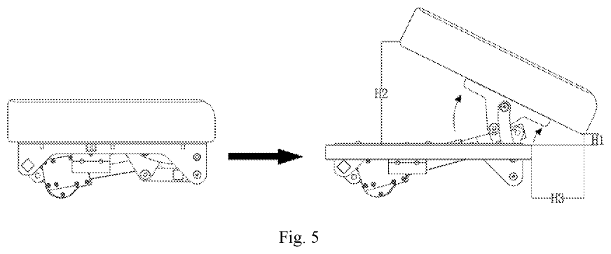

As shown in FIGS. 3-5, in an embodiment, the lifting mechanism 32 includes two linkage assemblies 321 and a crossbar 322. The two linkage assemblies 321 are respectively mounted on sides of the two fixing plates 311 that are opposite to each other. The two linkage assemblies 321 are respectively hinged to the two fixing plates 311. The two linkage assemblies 321 are connected to each other via the crossbar 322. The driving mechanism 33 is hinged to the crossbar 322.

In this embodiment, the two linkage assemblies 321 are arranged symmetrically to form a foldable linkage structure. When the driving mechanism 33 applies a pushing or pulling force to the linkage assemblies 321 via the crossbar 322, the linkage assemblies 321 on both sides extend or contract synchronously, thereby driving the seat cushion 2 to achieve stable lifting and flipping motion. The crossbar 322 not only ensures the coordinated movement of the two linkage assemblies 321, preventing tilting of the seat cushion 2 caused by uneven force on a single side, but also provides a convenient and stable connection point for the driving mechanism 33, allowing the driving force to be transmitted more evenly and efficiently throughout the lifting mechanism 32.

In an embodiment, each linkage assembly 321 includes a first linkage part 3211, a second linkage part 3212, and a lifting part 3213. A first end of the first linkage part 3211 is hinged to a corresponding one of the fixing plates 311, and a second end of the first linkage part 3211 is hinged to a first side of the lifting part 3213. A first end of the second linkage part 3212 is hinged to the corresponding one of the fixing plates 311, and a second end of the second linkage part 3212 is hinged to a second side of the lifting part 3213. The first linkage part 3211 of one of the two linkage assemblies 321 is fixedly connected to a first end of the crossbar 322, and the first linkage part 3211 of the other of the two linkage assemblies 321 is fixedly connected to a second end of the crossbar 322. The lifting part 3213 is fixedly connected to the seat cushion 2.

In this embodiment, the first end of the first linkage part 3211 is hinged to the corresponding one of the fixing plates 311 via a first hinged shaft 3214, and the second end of the first linkage part 3211 is hinged to the first side of the lifting part 3213 via a second hinged shaft 3215. The first end of the second linkage part 3212 is hinged to the corresponding one of the fixing plates 311 via a third hinged shaft 3216, and the second end of the second linkage part 3212 is hinged to the second side of the lifting part 3213 via a fourth hinged shaft 3217. Lines connecting the first hinged shaft 3214, the second hinged shaft 3215, the third hinged shaft 3216, and the fourth hinged shaft 3217 form a quadrilateral.

An end of the second hinged shaft 3215 is configured to extend through the lifting part 3213. A length of the end of the second hinged shaft 3215 extending through the lifting part 3213 is greater than or equal to a length of the fourth hinged shaft 3217. With this configuration, when the second hinged shaft 3215 comes into contact with the second linkage part 3212, rotation of the first linkage part 3211 and the second linkage part 3212 is restricted, thereby preventing the seat cushion 2 from being excessively lifted or flipped.

The first linkage part 3211, the second linkage part 3212, and the lifting part 3213 are sheet-metal components.

Specifically, a distance between the first hinged shaft 3214 and the second hinged shaft 3215 is 110.8 mm. A distance between the first hinged shaft 3214 and the third hinged shaft 3216 is 38.5 mm. A distance between the third hinged shaft 3216 and the fourth hinged shaft 3217 is 110.9 mm. A distance between the second hinged shaft 3215 and the fourth hinged shaft 3217 is 52.1 mm.

During operation, the driving mechanism 33 pushes or pulls the crossbar 322, causing the crossbar 322 to rotate. Rotation of the crossbar 322 synchronously drives the first linkage parts 3211 on both sides to rotate about the corresponding first hinged shafts 3214. Since the first linkage part 3211, the second linkage part 3212, the fixing plates 311, and the lifting part 3213 are hinged via hinged shafts to form a quadrilateral linkage structure, rotation of the first linkage part 3211 causes the second linkage part 3212 to rotate accordingly about the third hinged shaft 3216. At this time, the quadrilateral linkage structure changes its configuration, and under combined action of the first linkage part 3211 and the second linkage part 3212, the lifting part 3213 undergoes combined upward or downward translational and flipping motion.

Specifically, when the driving mechanism 33 drives the crossbar 322 to move forward and rotate, second ends of the first linkage parts 3211 and second ends of the second linkage parts 3212 connected to the lifting part 3213 swing away from the fixing plates 311, thereby lifting the lifting part 3213 and the seat cushion 2 fixed thereto upward while simultaneously causing the lifting part 3213 and the seat cushion 2 to undergo sector-shaped flipping, so as to adjust a posture of the seat cushion 2 and assist the user in standing up from a seated state more easily. When the user needs to sit down or when the seat cushion 2 is to be reset, the driving mechanism 33 pulls the crossbar 322 to move rearward and rotate, such that the second ends of the first linkage parts 3211 and the second ends of the second linkage parts 3212 connected to the lifting part 3213 swing toward the fixing plates 311, and the seat cushion 2 is thereby smoothly returned to an initial horizontal seated position.

In an embodiment, the driving mechanism 33 includes a telescopic push rod 331 and a motor 332. The second cross beam 313 is fixedly sleeved with a first hinged plate 3131. The crossbar 322 is fixedly sleeved with a second hinged plate 3221. A first end of the telescopic push rod 331 is hinged to the first hinged plate 3131, and a second end of the telescopic push rod 331 is hinged to the second hinged plate 3221. The motor 332 is mounted on an outer wall of the telescopic push rod 331.

In this embodiment, the motor 332 serves as a driving source to provide power to the telescopic push rod 331.The motor 332 is configured to drive a piston rod of the telescopic push rod 331 to extend outward or retract inward.

During operation, when the motor 332 drives the telescopic push rod 331 to extend outward, the telescopic push rod 331 applies a forward pushing force to the second hinged plate 3221, thereby driving the crossbar 322 to move forward and rotate about a connection point between the crossbar 322 and the first cross beam 312. The rotation of the crossbar 322 in turn drives the first linkage parts 3211 connected thereto to rotate about the corresponding first hinged shafts 3214. Through coordinated action of the quadrilateral linkage structure, the seat cushion 2 is lifted upward while simultaneously undergoing a sector-shaped flipping motion, thereby assisting the user in standing. Conversely, when the motor 332 drives the telescopic push rod 331 to retract inward, a rearward pulling force is applied to the second hinged plate 3221, thereby causing the crossbar 322 to move rearward and rotate in an opposite direction about the connection point, and further driving the seat cushion 2 to descend smoothly and return to an initial horizontal position through the quadrilateral linkage structure.

In an embodiment, the sit-to-stand assist chair further includes a power supply 34. The power supply 34 is mounted on the mounting frame 31. The power supply 34 provides stable electrical power to the motor 332 of the driving mechanism 33, thereby ensuring that the motor 332 can normally drive the telescopic push rod 331 to operate. In some embodiments, the power supply 34 may be implemented as a rechargeable lithium battery having a relatively large capacity and a long operating duration, thereby enabling portable operation of the assist chair without requiring frequent connection to an external power source.

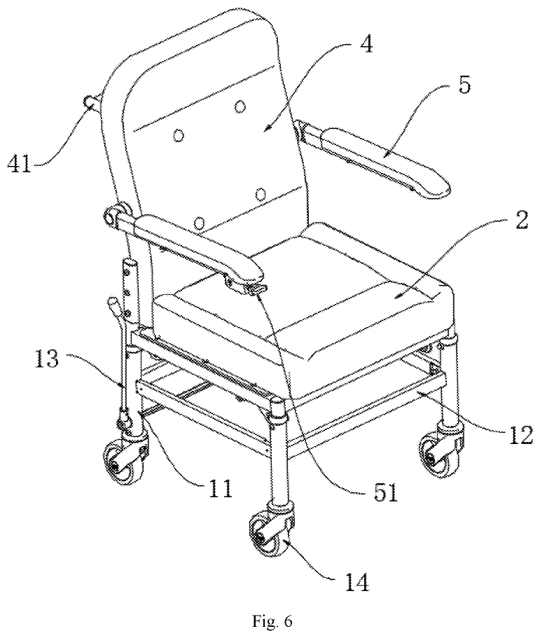

As shown in FIG. 6, in an embodiment, the base 1 includes four support legs 11 and a plurality of connecting rods 12. The four support legs 11 are each arranged vertically. Two adjacent support legs 11 of the four support legs 11 are fixedly connected to each other via at least one of the plurality of connecting rods 12, such that the four support legs 11 and the plurality of connecting rods 12 together form a rectangular frame structure.

In this embodiment, the connecting rods 12 are made of a high-strength alloy material, which provides sufficient structural strength for the base 1 while reducing the overall weight of the base 1. The rectangular frame structure is designed to distribute loads applied to the assist chair more evenly, thereby enhancing the stability of the base 1.

In an embodiment, each of the support legs 11 is a telescopic rod. An outer wall of each support leg 11 is provided with an adjustment rod 13.

In this embodiment, the telescopic state of the support legs 11 can be adjusted by operating the adjustment rods 13. A user may modify the overall height of the assist chair by changing the lengths of the support legs 11 based on their height or usage needs, thereby achieving a more comfortable sit-to-stand experience.

In an embodiment, each support leg 11 is provided with a caster wheel 14.

In this embodiment, the caster wheels 14 are configured to allow flexible changes in the movement direction of the assist chair, enabling a user to easily maneuver the assist chair to a desired location according to the actual usage scenario, such as from the living room to the balcony or from beside a dining table to near a sofa, thereby significantly enhancing overall mobility and convenience.

In an embodiment, the sit-to-stand assist chair further includes a backrest 4. The backrest 4 is fixedly mounted on the base 1. Two sides of the backrest 4 are each provided with a rotatable armrest 5.

In this embodiment, the rotatable armrests 5 are rotatable within a range of 0° to 90°. When seated, a user may rotate the rotatable armrests 5 upward to a horizontal position to provide elbow support and reduce shoulder load. During standing, the rotatable armrests 5 can serve as leverage points to assist the user in rising more easily. When cleaning or relocating the chair, the rotatable armrests 5 may be rotated downward to align with the two sides of the backrest 4, thereby minimizing the space occupied.

In an embodiment, one of two rotatable armrests 5 is provided with a control button 51.

In this embodiment, the control button 51 is connected to a drive module inside the assist chair. When the user intends to stand, pressing the control button 51 causes the lifting assembly 3 to raise the seat cushion 2 as a whole and rotate the seat cushion 2 by a certain angle, thereby forming an assisting inclined surface that helps the user rise more easily by leveraging support from the seat cushion 2.

In an embodiment, a side of the backrest 4 away from the seat cushion 2 is provided with a handle 41.

In this embodiment, when the assist chair needs to be moved, a user can stand behind the backrest 4, firmly grasp the handle 41 with both hands, and push or pull the handle 41 to change the position of the assist chair.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A sit-to-stand assist chair, comprising:
a base;
a seat cushion; and
a lifting assembly;
wherein the seat cushion is movably mounted on the base;
the lifting assembly comprises a mounting frame, a lifting mechanism and a driving mechanism;
the mounting frame is mounted on the base;
the lifting mechanism is mounted on the mounting frame;
a bottom of the seat cushion is connected to the lifting mechanism;
the driving mechanism is mounted on the mounting frame; and
the driving mechanism is configured to drive the lifting mechanism to lift the seat cushion and simultaneously drive the seat cushion to entirely perform a sector-shaped flipping motion.

2. The sit-to-stand assist chair of claim 1, wherein the mounting frame comprises two fixing plates, a first cross beam and a second cross beam;
the two fixing plates are arranged spaced apart from each other, and are mounted on the base;
the first cross beam and the second cross beam are arranged spaced apart from each other, and are provided between the two fixing plates;
a first end of each of the first cross beam and the second cross beam is fixedly connected to one of the two fixing plates, and a second end of each of the first cross beam and the second cross beam is fixedly connected to the other of the two fixing plates;
the lifting mechanism is hinged to an end of each of the two fixing plates away from the second cross beam; and
a first end of the driving mechanism is hinged to the second cross beam, and a second end of the driving mechanism is hinged to the lifting mechanism.

3. The sit-to-stand assist chair of claim 2, wherein the lifting mechanism comprises two linkage assemblies and a crossbar;
the two linkage assemblies are respectively mounted on sides of the two fixing plates that are opposite to each other;
the two linkage assemblies are respectively hinged to the two fixing plates;
the two linkage assemblies are connected to each other via the crossbar; and
the driving mechanism is hinged to the crossbar.

4. The sit-to-stand assist chair of claim 3, wherein each of the two linkage assemblies comprises a first linkage part, a second linkage part and a lifting part;
a first end of the first linkage part is hinged to a corresponding one of the two fixing plates, and a second end of the first linkage part is hinged to a first side of the lifting part;
a first end of the second linkage part is hinged to the corresponding one of the two fixing plates, and a second end of the second linkage part is hinged to a second side of the lifting part;
the first linkage part of one of the two linkage assemblies is fixedly connected to a first end of the crossbar, and the first linkage part of the other of the two linkage assemblies is fixedly connected to a second end of the crossbar; and
the lifting part is fixedly connected to the seat cushion.

5. The sit-to-stand assist chair of claim 4, wherein the first end of the first linkage part is hinged to the corresponding one of the two fixing plates via a first hinged shaft, and the second end of the first linkage part is hinged to the first side of the lifting part via a second hinged shaft;
the first end of the second linkage part is hinged to the corresponding one of the two fixing plates via a third hinged shaft, and the second end of the second linkage part is hinged to the second side of the lifting part via a fourth hinged shaft; and
lines connecting the first hinged shaft, the second hinged shaft, the third hinged shaft and the fourth hinged shaft form a quadrilateral.

6. The sit-to-stand assist chair of claim 3, wherein the driving mechanism comprises a telescopic push rod and a motor;
the second cross beam is fixedly sleeved with a first hinged plate;
the crossbar is fixedly sleeved with a second hinged plate;
a first end of the telescopic push rod is hinged to the first hinged plate, and a second end of the telescopic push rod is hinged to the second hinged plate; and
the motor is mounted on an outer wall of the telescopic push rod.

7. The sit-to-stand assist chair of claim 1, wherein the base comprises four support legs and a plurality of connecting rods; and the four support legs are each arranged vertically;
two adjacent support legs of the four support legs are fixedly connected to each other via at least one of the plurality of connecting rods, such that the four support legs and the plurality of connecting rods together form a rectangular frame structure.

8. The sit-to-stand assist chair of claim 7, wherein each of the four support legs is a telescopic rod; and an outer wall of each of the four support legs is provided with an adjustment rod.

9. The sit-to-stand assist chair of claim 1, further comprising:
a backrest;
wherein the backrest is fixedly mounted on the base; and two sides of the backrest are each provided with a rotatable armrest.

10. The sit-to-stand assist chair of claim 9, wherein one of two rotatable armrests is provided with a control button.
